(19) United States
(12) Patent Application Publication
(10) Pub. No.: US 2002/0143607 A1
(43) Pub. Date: Oct. 3, 2002

(54) System and method for transparently obtaining customer preferences to refine product features or marketing focus

(76) Inventor: Jay H. Connelly, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/823,421

(22) Filed: Mar. 29, 2001

(51) Int. Cl. G06F 17/60

(52) U.S. Cl. 705/10

(57) ABSTRACT

System and method for transparently obtaining consumer preferences for products, product features and product marketing. A method comprises receiving a request to obtain consumer feedback. At least one product description data is then sent to a plurality of clients. After receiving feedback data from the plurality of clients transparent to the user of the clients, a consumer feedback summary based on the feedback data is processed. The method may be implemented on a system such as a computer.

### FIELD OF THE INVENTION

The invention relates generally to broadcast systems and, more specifically, to obtaining consumer feedback in a broadcast system and delivering it to a requesting third party.

### BACKGROUND OF THE INVENTION

Broadcast systems traditionally transmit data in one direction from a server system to a plurality of client systems. Consumers of the client systems typically receive the signals from the server system as they are broadcast. One paradigm in which consumers are provided with content on demand involves server systems that broadcast the same data continuously and/or at staggered intervals, such as, for example “pay per view” movies. “Pay per view” movies are available from cable or satellite television broadcaster that send the same movies repeatedly on multiple channels at staggered intervals. Consumers that wish to watch a particular movie “on demand” simply tune in to one of the channels on which the desired movie is broadcast at a particular known broadcast time.

Another paradigm for providing content on demand in a broadcast system involves a consumer recording a particular program, movie, sporting event, or other content, and later accessing it “on demand” at a time after it was broadcast. Traditionally, a consumer sets a video cassette recorder (VCR) to record a desired television program. Later, when the consumer wishes to watch the television program, the consumer simply plays the earlier recorded program from the VCR. Recently, digital video recorders paired with digital broadcast services provided by TiVo, Inc. of Alviso, Calif. and Replay TV, Inc. of Mountain View, Calif. have become available. These paired device and service offerings allow for content broadcasts to be recorded on internal hard disk drives rather than the video cassette tapes used by traditional VCRs. However, use of digital video recorders is similar to traditional VCRs in that consumers explicitly set the criteria used to determine which broadcasts are recorded on the internal hard drives by specifying a date and time of a desired program or other content.

Current broadcast systems do not allow consumers to provide feedback to broadcasters regarding likes, preferences, favorites, etc. For example, many of today's television broadcasters rely upon ratings from Nielsen Media Research of New York, N.Y. to determine broadcast programming and/or scheduling. These ratings are estimates of numbers of viewers of television programs based upon surveys provided to only a relatively small sampling of a cross-section of the public. Preparation of these surveys is time consuming and expensive. As such, content providers cannot easily and inexpensively determine what content consumers most want to view. Consequently, television viewers have little direct impact on broadcast schedules and/or content. Similarly, current broadcast systems do not provide a way for content providers to receive feedback from consumers, to provide content based on known consumer preferences and favorites, to develop content based on known consumer preferences, and to market content based on known consumer preferences.

### BRIEF DESCRIPTION OF THE DRAWINGS

FIG. 1 illustrates an environment in which one embodiment of the invention executes as part of a broadcast center server.

FIG. 2A illustrates product description data according to an embodiment of the invention.

FIG. 2B illustrates feedback data according to an embodiment of the invention.

FIG. 3 illustrates a general flow of actions taken pursuant to one embodiment of the invention.

FIG. 4 illustrates a flow actions taken pursuant to one embodiment of the invention in which customer demand for multiple products may be compared.

FIG. 5 illustrates a flow of actions taken pursuant to one embodiment of the invention in which the effectiveness of multiple ways of marketing a product may be compared.

### DETAILED DESCRIPTION OF THE INVENTION

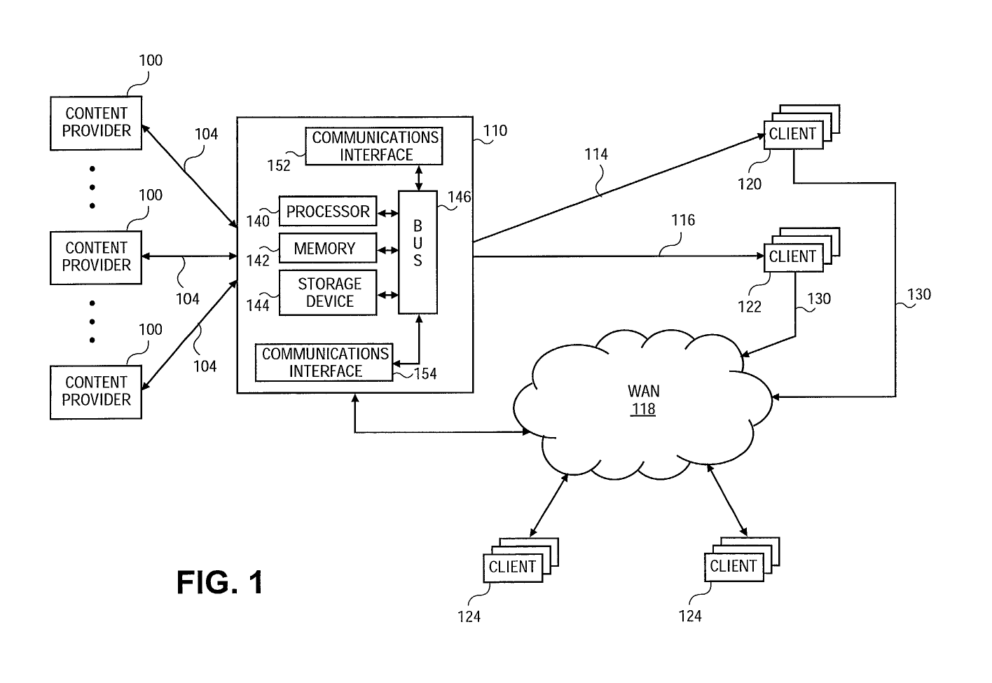

FIG. 1 illustrates an environment in which one embodiment of the invention executes as part of a broadcast center server. The invention involves at least one content provider 100 that provides a product to a broadcast center server 110. The content provider may provide the product in an analog or a digital format. If the product is recorded in an analog format, it may be converted into a digital format by broadcast center server 110. Each content provider 100 may be a server computer or a group, subnetwork, local area network (LAN) or other group of multiple computers. The product may be a television program, movie, short, raw data, voice, audio, video, graphics, or some combination of these or other similar data. In one embodiment, the content provider provides the product via connections 104. In one embodiment, connections 104 may be a land line such as T1 lines, T3 lines, coaxial cable, Ethernet, twisted-pair, fiber optic such as a Synchronous Optical Network (SONET), or other physically present connection. In another embodiment, the connection may be wireless in the form of microwave, satellite, radio waves, and the like. Broadcast center server 110 may be a server computer or a group of computers including a subnetwork, cluster or a LAN. Broadcast center server 110 distributes the product to consumers such as clients 120, 122, and 124. In one embodiment, the products sent to the clients are sent in a digital format.

In one embodiment, broadcast center server 110 is comprised of one or more server computers that include a processor 140, a memory 142 such as any Random Access Memory (RAM) device, a storage device 144 to store data received from the content providers and the clients, and at least one communications interface. In one embodiment, multiple communications interfaces 152 and 154 are required for communication with content providers as already described, and for communication with clients as will be described below. Storage device 144 may be any machine readable medium including hard disk drives, optical disk drives, magnetic tape, etc. Software implementing the method described herein may be stored on the storage device or other machine readable medium included in the broadcast center server, including magnetic and optical disks; magnetic tape; read-only memory (ROM), programmable read-only memory (PROM), electronically erasable programmable memory (EEPROM), and similar semiconductor devices; or may be downloaded from any external or remote device via electrical, acoustical, or other form of propagated signal (e.g., carrier waves, digital signals, infrared signals, etc.).

Processor 140, a memory 142, storage device 144, and communications interfaces 152 and 154 may be coupled to one another via bus 146. In various embodiments, computing device 120 may include multiple or additional communications interfaces, processors, storage devices, display adapters, and buses. Although not shown, user input devices such as a mouse and a keyboard, and a display such as a cathode ray tube (CRT) display monitor, or any display device suitable for displaying graphics and images, may be coupled to or included as part of the broadcast center server. In one embodiment in which the broadcast center server is comprised of multiple server computers, there may be dedicated communications servers, applications servers, storage servers, and other specialized servers configured as a LAN, group, subgroup, cluster, subnetwork, and the like.

The clients that receive products may be a computing device such as a set-top box, personal computer, portable computer, cellular telephone, personal digital assistant (PDA), computing tablet, or any other device containing a processor with a communications interface that allows for the receipt of data distributed via connections 114, 116 or 118. The computing device may also include a non-volatile storage device for storing received product, product description data, feedback data, etc. Such storage devices include magnetic media such as hard disk drives. In one embodiment, some of a plurality of clients include clients 120 which receive broadcast products wirelessly via a digital television (DTV) connection 114; some of a plurality of clients include clients 122 which receive broadcast products via satellite connection 116; and, some of a plurality of clients include clients 124 which receive broadcast products via a wide area network (WAN) connection 118. In this embodiment, the WAN may be the Internet. In another embodiment, some of a plurality of clients may receive broadcast product via cable television (CATV) connection, not shown. In one embodiment, a CATV connection may be a WAN.

In one embodiment, clients 120, 122 and 124 may also send information to the broadcast center server 110. For clients that receive broadcast products via a satellite, radio wave or other wireless connection, communication to the broadcast center may be achieved via telephone dial-up connection 130 through WAN 118, such as, for example, by connecting over the Internet. In other embodiments, these clients may dial-up directly to the broadcast center server. For clients that receive broadcast products via a WAN, such as via the Internet or CATV, communication to the broadcast center server may be made via the WAN through which broadcast products are received, such that the flow of information is bi-directional.

In one embodiment, content description information or product description data known as meta-data is sent to the client before a particular product is to be broadcast by the broadcast center server. In one embodiment, unknown to the consumer, the client, in the form of a smart set-top box or other personal computing device, in response to receiving product description data, effectively places an order for products to be delivered based on prior consumed product history, such as prior viewed movies and television shows, and/or based on consumer specified preferences. For example, if the consumer has viewed or specified action movies or movies starring Arnold Schwarzenegger, when an action movie, a movie starring Arnold Schwarzenegger, or a movie featuring a similar star is described in meta-data sent to the consumer's set-top box, the set-top box will respond and request that the movie described by the meta-data be transmitted to the set-top box. That is, clients 120, 122 and 124 are connected to the broadcast center server and run a client software program that maintains consumer preferences based on the history of all products which the client has consumed, has sought information for, or has otherwise accessed and/or based on consumer specified preferences. Accordingly, whenever the broadcast center server sends information to clients informing them that certain products will be available for download, the consumer's set-top box or other computing device responds automatically that certain kinds of products should be downloaded and others should be ignored. In this way, a consumer's preferences may be determined and anticipated such that products are automatically downloaded from the broadcast server to the client transparent to the consumer, that is, without the consumer performing any action or observing any activity.

Initially, in various embodiments no products tailored to the consumer are automatically delivered to the client until the consumer has a consuming history created by selecting and requesting that a product be downloaded by viewing programs or products, and/or by entering consumer preferences. In one embodiment, the client system may present menus of choices to the consumer to prime the automatic download/delivery system. For example, these menus may include check-off boxes for well-known genres, subgenres, styles, geographic location of the content, stars, directors, musical performers, etc. In another embodiment, the broadcast center may initially deliver products based on the geographic location of the client obtained as geographic data received from the client.

The invention involves a system such as that described regarding FIG. 1 in which a meta-data or product description information received by the broadcast center server is sent to clients, and client-side software responds automatically and transparently, without any user input. In one embodiment, the client responds whether the particular product should be transmitted or otherwise delivered to the client based on consumer preference information maintained by the client's set-top box or personal computing device. In another embodiment, the client responds with feedback data which will be described below.

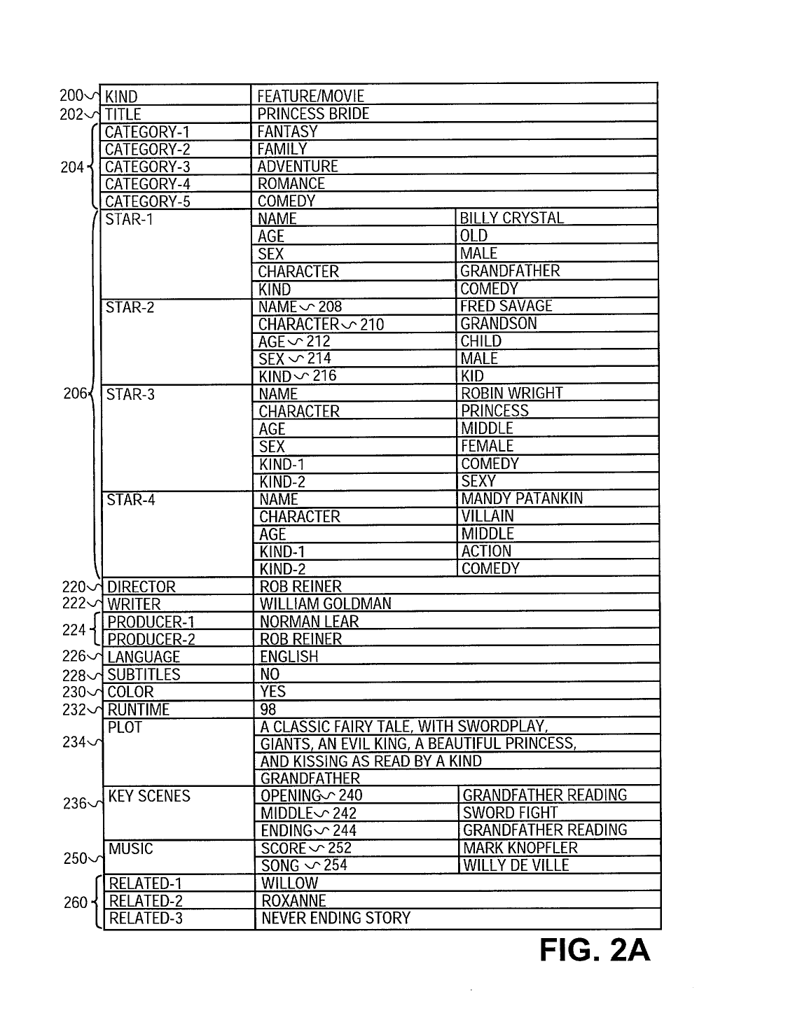

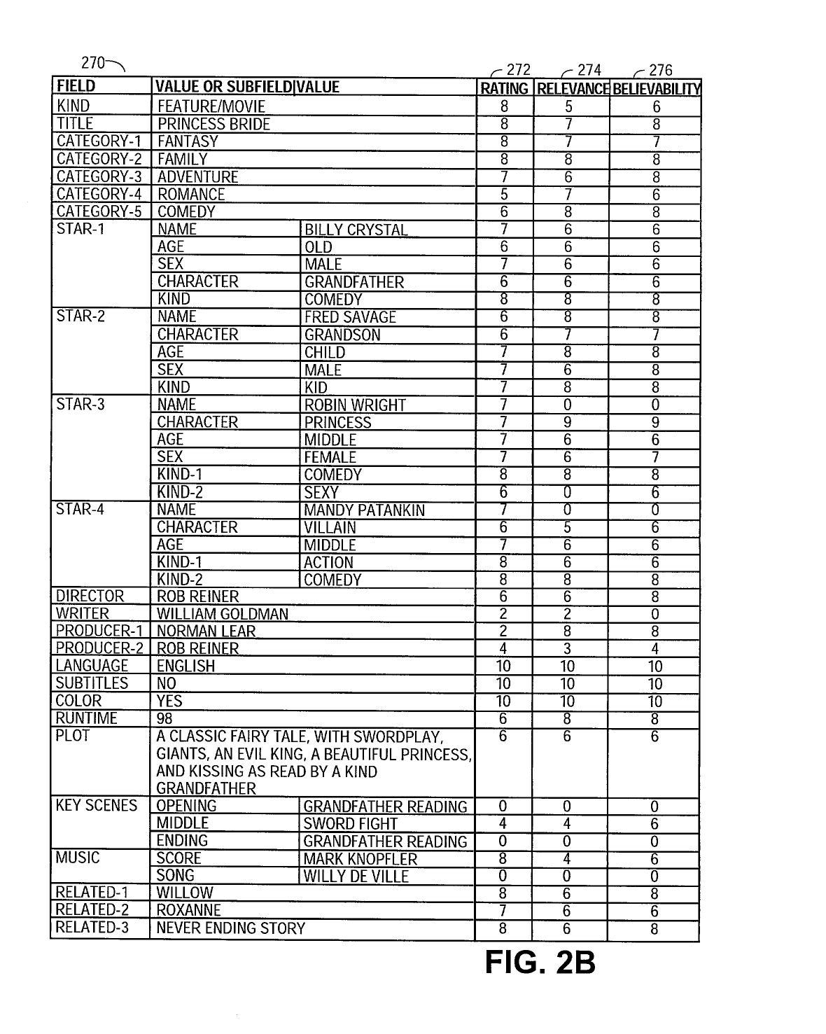

FIG. 2A illustrates product description data according to an embodiment of the invention. The product description data may have many fields describing the particular product. If the product is a movie, feature, short, television, program, and the like, product description data may include fields and values like those illustrated in FIG. 2A. The fields may include a kind 200, title 202, episode, one or more categories 204, one or more stars 206, one or more directors 220, one or more writers 222, one or more producers 224, language 226, subtitles 228, color 230, runtime 232, one or more plot descriptors 234, one or more key scenes 236, music 250, and one or more related products 260.

Depending on the kind of product, the fields may vary. For example, if the kind is television program, then there will be an episode category which is not used when the kind is movie, sporting event, news, etc. In one embodiment, not all fields are mandatory, but the fields are used when appropriate or applicable to the kind of product or the particular instance of the product. Some fields may have sub-fields as needed, and may have further information in sub-sub-fields, etc. For example, in one embodiment, for each star 206, there may be sub-fields for name 208, character played 210, age of the character played 212, sex of the character played 214, and one or more sub-fields for the kind of character played 216. Similarly, key scenes 236 may have sub-fields of opening 240, middle 242, and ending 244. Further, music may have sub-fields for score composer 252 and songs in the product 254. Although only one song 254 is illustrated, multiple songs may be included when appropriate. Additional sub-fields and sub-sub-fields may be used to further describe the kind of music used in the score or song(s) used in the product.

These fields and sub-fields are only examples, and the number and kind of fields, sub-fields, etc. are unlimited. Other fields may include Motion Picture Association of America (MPAA) rating and/or other third party ratings; parental guide classifications such as violence, sex, language, nudity, etc; geographic location; culture; race; religion; etc.

The data stored as the product description data may be represented in any well known form and may include text such as title 202, numeric data such as runtime 98, and Booleans such as, for example, color 230. Some fields may allow for a single term or word such as category 204, and others may allow for multiple words such as plot 234. The content of the fields and the fields themselves may vary depending on the product and the content provider.

The product description data may also be referred to as meta-data and may also accompany a product when it is delivered to the clients. In one embodiment, the product description data may initially be provided by content providers in the form of program guide information. In another embodiment, the product description data may be in another format and may be received by the broadcast center server. In this embodiment, the broadcast center server may convert or reformat the product description data as program guide information.

FIG. 2B illustrates feedback data according to one embodiment of the invention. The method described herein assumes that the clients are capable of responding to product description data with feedback data. In one embodiment, the feedback data may simply be a simple request for the product described in the description data. In this embodiment, the feedback data may include a product identifier of some kind, or product identifying data, paired with a request. In another embodiment, or in response to a request to provide more detailed feedback data, the broadcast center server may receive feedback data 270. In this embodiment, for each field, sub-field, etc. of the description data, the feedback data 270 includes a rating 272, and, in some embodiments, relevance data 274 and believability data 276. In one embodiment, the relevance data 274 and believability data 276 may be represented as vectors, such that they range from −10 to +10. In this way the broadcast center server may determine not just whether a consumer at the client prefers a product, but may also deduce the particular reasons based on the feedback data associated with particular product attributes as delineated by the fields. In various embodiments, one, or both of the relevance and believability values may be used with the rating value.

In one embodiment, the rating may either be explicitly input by a consumer or implicitly generated by the client system by processing meta-data associated with other products requested, viewed or otherwise accessed by the consumer. In one embodiment, a relatively high rating value predicts that the particular product may be of interest to the consumer. Conversely, in one embodiment, a relatively low rating value predicts that the particular product is unlikely to be of interest to the consumer. In one embodiment, the rating may include a sub-field referred to as “type,” not shown. In a related embodiment, a separate field called “rating type” may be used. The “type” sub-field or “rating type” field may indicate whether the rating value was a result of explicit input from the consumer or if the rating value was implicitly generated by the client system. How the rating is determined may vary depending on the particular client implementation. Important to the invention described herein is that ratings for the product and/or for fields of meta-data are received by the broadcast center server from clients.

In one embodiment, the relevance values in the feedback data are indicators as to how relevant the associated attribute and attribute values are for predicting a particular consumer's behavior. The relevance value indicates how likely it is for the consumer to view a particular product because of the particular attribute value. The relevance values are larger if, for example, the consumer has already requested or viewed one or more products having that particular attribute value. Conversely, the relevance values are smaller if, for example, the consumer has never viewed or requested a product having that particular attribute value. Similarly, if the consumer explicitly stated in entering preferences that products having the particular attribute are desired or should be excluded, the relevance value will be impacted accordingly.

In one embodiment, the believability values in the feedback data are used to predict the accuracy of the rating. These values are used by the broadcast center server to evaluate whether a consumer will actually view or otherwise access a particular requested product. In one embodiment, the believability values are larger when an attribute value has been shown to accurately predict a product a consumer has viewed or otherwise accessed. Conversely, the believability factors are smaller when, even though a consumer may appear to be interested in the product, the consumer has been shown to not have viewed or otherwise accessed the product after it was delivered.

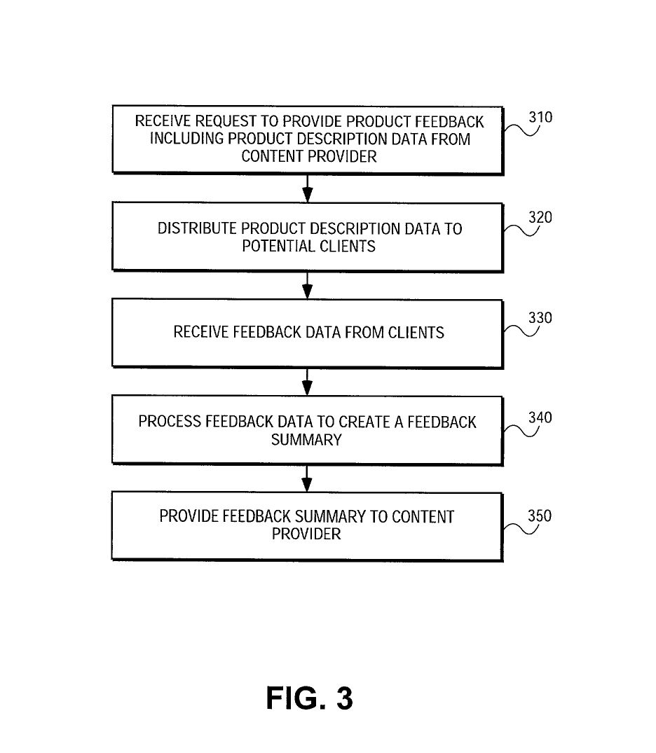

FIG. 3 illustrates a general flow of actions taken pursuant to one embodiment of the invention. In one embodiment, the broadcast center server receives a request to provide product feedback including product description data from a content provider, as shown in block 310. In one embodiment, a marketing company or other third party representing the content provider may replace the content provider. The broadcast center server then distributes the product description data to potential clients, as shown in block 320. The broadcast center server receives feedback data from clients, as shown in block 330. In one embodiment, the feedback data is a simple request for the delivery of content that the client determines the consumer will enjoy based on a comparison of the preferences stored in the consumer's set-top box and the product description data sent by the broadcast center server. In another embodiment, the feedback data may be more detailed and may include detailed information concerning each of the fields of the content description data such as rankings, ratings, relevance, etc. as described above regarding FIG. 2B. In this way, the broadcast center server may readily determine the reasons why a particular product would be transparently ordered for delivery.

In one embodiment, a response declining the product described may be a simple message, or may be no message at all, such that only positive feedback is provided. In another embodiment, a response declining the product described may include detailed feedback data that may be used to determine the reasons why the product would be transparently declined. The broadcast center server then processes the feedback data to create a feedback summary, as shown in block 340. The broadcast center server then provides a feedback summary to the content provider, or third party acting on behalf of the content provider, as shown in block 350. The feedback summary may, in a simple embodiment, provide a listing of the percentages of clients that requested a particular product based on the product description data provided. In a more detailed embodiment, the feedback summary may be a compilation of all of the feedback data received from clients and may include raw tallies by category, reliability estimates, and may also include conclusions extrapolated from the raw tallies.

In its most simple use, in one embodiment, the method of the invention may be used to test the demand for a product, to obtain information about the demand for a particular product. In this embodiment, product description data for the product is sent by the broadcast center server to all clients. The broadcast center server may then calculate a raw tally of the number of clients who requested the product, prepare a summary and send it to the content provider. The product, in this embodiment, may be a real product such as a completed film, a product under development such as a film currently being shot, or a product that is only being considered for development such as a script that has not yet been made into a film.

In one embodiment, the method of the invention may be used to obtain information valuable to those determining how to refine or otherwise embellish, complete, or accessorize a particular product. In various embodiments, the products may be multiple versions of the same prototype or unfinished product, or may be multiple products. In one embodiment, the products may be real products that are readily available, such that it may be determined whether a preference for one product over one or more other products among the totality of clients exists.

In one embodiment involving prototypes, features or characteristics of a not yet fully completed product may be refined based on the popularity of the features and characteristics among the clients. By using this method, the characteristics of a product that has not been completed may be provided in multiple versions of product description data with varying attributes, features or characteristics to determine in which configuration the product will be more successful. In this embodiment, the feedback summary may also include attribute success comparison data processed by the broadcast center server that may include relevance data, believability data, reliability estimates, and/or extrapolated conclusions.

In one embodiment, success is measured simply by the number of clients requesting the product. One such example may be determining which actor should star in a particular movie. This may be achieved by providing three sets of product description data for a movie, one each with stars A, B and C in a particular role. If there is minimal difference in the success of responses to the three versions of product description data, the content provider may choose to focus its efforts elsewhere. However, if the success rates vary greatly, then the content provider may choose to make it a priority to hire the star with the highest success rate or the stars with the higher success rates to play the particular role in the movie. In other examples, this method may be used for story endings, directors or any other characteristic that may be used to describe products such as movies, television programs, shorts, animated features, etc. that may be expressed as product description data.

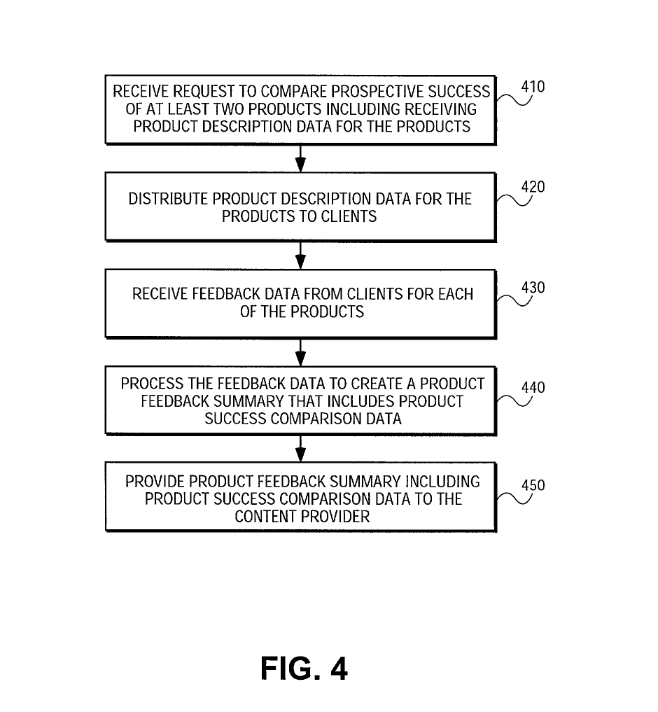

FIG. 4 illustrates a flow actions taken pursuant to one embodiment of the invention in which customer demand for multiple products may be compared. This flow is initiated when the broadcast center server receives a request to compare the prospective success of at least two products including receiving product description data regarding the products, as shown in block 410. The product may be two or more competing products, or multiple versions of a product in development, for example. Product description data for each of the products is then distributed to potential clients, as shown in block 420. The broadcast center server then receives feedback data for each of the products from the potential clients, unknown and transparent to the actual consumer, as shown in block 430. In one embodiment, the broadcast center server may receive simple data such as whether the product should be delivered or whether it should not. In this way, the client requests what it believes is a true product, when all that is being sent is meta-data for a product comparison test. No product will be sent in response to the client's request. In another embodiment, more detailed data expressing a ranking, etc. as discussed above regarding FIG. 2B may be received.

The broadcast center server processes the feedback data to create a product feedback summary that includes product success comparison data, as shown in block 440. The product feedback summary including product comparison data is then provided to the content provider, as shown in block 450. In one embodiment, the product success comparison data is determined by analyzing which product was requested by more clients than the other products.

In another embodiment, the method may obtain information valuable to those determining how to market a particular product. In this embodiment, the marketing focus may be varied by sending different versions of product description data, each highlighting a different aspect of the content, such as the appearance of a director, band performing on the soundtrack, star, supporting actor, genre, sub-genre, etc. In this way, a preference for the product based on one or more marketing choices may be determined.

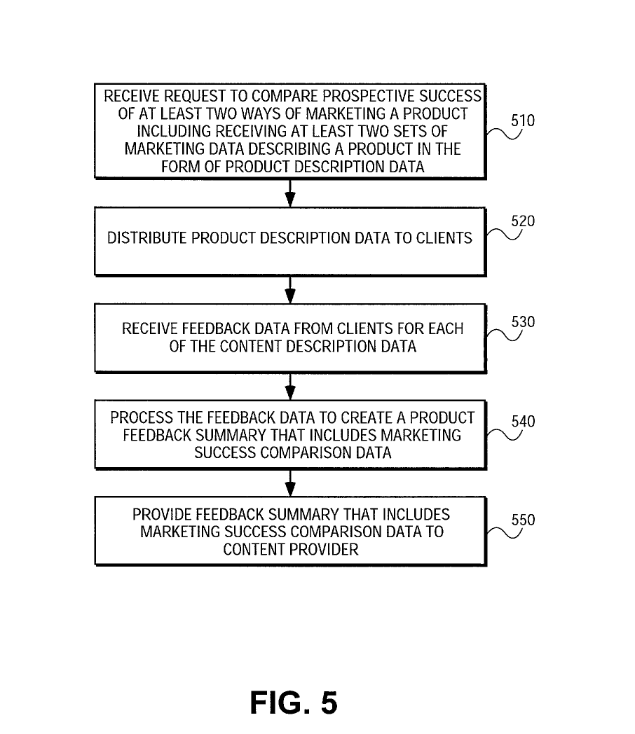

FIG. 5 illustrates a flow of actions taken pursuant to one embodiment of the invention in which the effectiveness of multiple ways of marketing a product may be compared. In this way, the marketing strategy for the product may be refined by the content provider or a marketing consultant. The flow is initiated when the broadcast center server receives a request to compare the prospective success of at least two ways of marketing a product, including receiving at least two sets of marketing data describing a product in the form of product description data, as shown in block 510. The product description data for the product is then distributed to clients, as shown in block 520. The broadcast center server then receives feedback data for each of the product description data from the clients, as shown in block 530. The broadcast center server processes the feedback data to create a feedback summary that includes marketing choice success comparison data, as shown in block 540. The feedback summary including marketing choice success comparison data is then provided to the content provider, as shown in block 550. In one embodiment, the marketing choice success comparison data is determined by analyzing which product description data caused the product to be requested by more clients. In another embodiment, more complex marketing success comparison data is provided in a feedback summary and may be based on more extensive feedback data such as that discussed above regarding FIG. 2B.

In the foregoing specification, the invention has been described with reference to specific embodiments. It will, however, be evident that various modifications and changes can be made without departing from the broader spirit and scope of the invention as set forth in the appended claims. The specification and drawings are, accordingly, to be regarded in an illustrative rather than a restrictive sense.

What is claimed is:

1. A method comprising:
receiving a request to obtain consumer feedback;
sending at least one product description data to a plurality of clients;
receiving a feedback data from each of the plurality of clients transparent to the user of the clients;
processing a consumer feedback summary based on the feedback data.

2. The method of claim 1 further comprising:
communicating the consumer feedback summary to a product provider

3. The method of claim 1 wherein the request to obtain consumer feedback is received from a product provider.

4. The method of claim 1 wherein the request to obtain consumer feedback comprises a request to test the success of one or more products.

5. The method of claim 4 wherein the consumer feedback summary comprises a product success data for each of the one or more products.

6. The method of claim 1 wherein the request to obtain consumer feedback comprises a request to compare the success of two or more attributes of a product.

7. The method of claim 6 wherein the consumer feedback summary comprises an attribute success comparison data.

8. The method of claim 1 wherein the request to obtain consumer feedback comprises a request to compare the success of two or more products.

9. The method of claim 8 wherein the consumer feedback summary comprises a product success comparison data.

10. The method of claim 1 wherein the request to obtain consumer feedback comprises a request to compare the success of two or more ways of marketing a product.

11. The method of claim 10 wherein the consumer feedback summary comprises a marketing success comparison data.

12. The method of claim 1 wherein the product description data comprises meta-data.

13. The method of claim 1 wherein the product description data comprises program guide information.

14. A system comprising a machine readable medium and a processor, the machine readable medium having instructions which when executed by the processor cause the system to perform operations comprising:
receiving a request to obtain consumer feedback;
sending at least one product description data to a plurality of clients;
receiving a feedback data from each of the plurality of clients transparent to the user of the clients;
processing a consumer feedback summary based on the feedback data.

15. The system of claim 14 in which the machine readable medium having further instructions which when executed by the processor cause the system to perform further operations comprising:
communicating the consumer feedback summary to a product provider

16. The system of claim 14 wherein the request to obtain consumer feedback is received from a product provider.

17. The system of claim 14 wherein:
the request to obtain consumer feedback comprises a request to test the success of one or more products; and
the consumer feedback summary comprises a product success data for each of the one or more products.

18. The system of claim 14 wherein:
the request to obtain consumer feedback comprises a request to compare the success of two or more attributes of a product; and
the consumer feedback summary comprises an attribute success comparison data.

19. The system of claim 14 wherein
the request to obtain consumer feedback comprises a request to compare the success of two or more products; and
the consumer feedback summary comprises a product success comparison data.

20. The system of claim 14 wherein:
the request to obtain consumer feedback comprises a request to compare the success of two or more ways of marketing a product; and
the consumer feedback summary comprises a marketing success comparison data.

21. The system of claim 14 wherein the product description data comprises meta-data.

22. The system of claim 14 wherein the product description data comprises program guide information.

23. A system comprising:
a processor coupled to a bus;
a memory coupled to the bus;
means for receiving a request to obtain consumer feedback;
means for sending at least one product description data to a plurality of clients;
means for receiving a feedback data from each of the plurality of clients transparent to the user of the clients;
means for processing a consumer feedback summary based on the feedback data.

24. The system of claim 23 further comprising:
means for communicating the consumer feedback summary to a product provider

25. The system of claim 23 wherein the request to obtain consumer feedback is received from the product provider.

26. The system of claim 23 wherein the product description data comprises meta-data.

27. The system of claim 23 wherein the product description data comprises program guide information.
